(19) United States
(12) Patent Application Publication
(10) Pub. No.: US 2015/0168204 A1
(43) Pub. Date: Jun. 18, 2015

(54) Method and device for determining a height of a fluid level in a fluid container

(71) Applicant: CONTINENTAL AUTOMOTIVE GMBH, Hannover (DE)

(72) Inventors: Peter Meyer, Roethenbach (DE); Karl-Friedrich Pfeiffer, Erlangen (DE)

(21) Appl. No.: 14/413,985

(22) PCT Filed: Jun. 27, 2013
(86) PCT No.: PCT/EP2013/063489

§ 371 Date: Jan. 9, 2015

(30) Foreign Application Priority Data
Jul. 12, 2012 (DE) 10 2012 212 210.9

(51) Int. Cl. G01F 23/296

(52) U.S. Cl. CPC G01F 23/2962

(57) ABSTRACT

A method and a device determine a height of a fluid level in a fluid container by: emitting a sound signal by a transmitter and recording sound signals reflected at the fluid level and at the reference elements; determining, for the recorded sound signals, a first propagation time difference between a first propagation time of the sound signal emitted by the transmitter and reflected at the first reference element and a second propagation time of the sound signal emitted by the transmitter and reflected at the second reference element; determining a second propagation time difference or a third propagation time difference; and determining the height of the fluid level based upon the first propagation time difference, the second propagation time difference and the first distance or based upon the first propagation time difference, the third propagation time difference and the second distance.

### CROSS-REFERENCE TO RELATED APPLICATIONS

This is a U.S. national stage of application No. PCT/EP2013/063489, filed on 27 Jun. 2013, which claims priority to the German Application No. DE 10 2012 212 210.9 filed 12 Jul. 2012, the content of both incorporated herein by reference.

### BACKGROUND OF THE INVENTION

1. Field of the Invention

The invention relates to a method and a corresponding device for determining a height of a fluid level in a fluid container.

2. Related Art

An acoustic measuring device, in particular, can be used for determining a height of a fluid level in a fluid container. A sound transducer of the acoustic measuring device can operate both as a sound generator and as a sound receiver. Sound pulses can be emitted into the fluid to be measured by means of the sound transducer in order to determine the height of the fluid level in the fluid container. The sound pulses can be reflected at an interface of the fluid to a further medium. Conclusions can be drawn about the height of the fluid level in the fluid container from the propagation time of the sound pulses.

Document GB 2 265 219 A describes an ultrasonic sensor system for establishing a fill level of a liquid in a container or a pipe, comprising a sensor, a plurality of reflectors and a sound transducer. Sound signals are transmitted into the pipe by means of the sound transducer, which is attached to a fastening plate at the bottom end of the pipe, and reflections of the sound signals are received at the reflectors and at the liquid surface.

A height of the fill level of the liquid in the container is established dependent on the measured arrival times of the respective reflections.

Document WO 91/02950 A1 discloses a measurement apparatus and a method for determining a fill level of a liquid in a tank, in which a fill level height is determined by the sound propagation time of ultrasonic pulses. Here, the measurement apparatus comprises a T-shaped measurement pipe, and a plurality of sound transmitters and receivers as well as temperature sensors, which are attached in or at the measurement pipe. Thus, a temperature-corrected speed of sound is established from measured speeds of sound and a temperature-dependent fill level height is determined in due course.

Document DE 10 2004 028547 A1 describes a further device for determining a level of a liquid in a tank. Here, the device comprises a transmitter/receiver, a bottom surface of the tank and two reference signal reflectors, which are arranged at known positions within the tank. Proceeding from the transmitter/receiver, ultrasonic signals are emitted, pass through a bottom wall of the tank and enter the liquid within the tank. As a result of propagation time measurements of the reflected ultrasonic pulses, a sound propagation time and a speed of sound are established, by means of which the level height is determined.

### SUMMARY OF THE INVENTION

An object of the invention is to develop a method and a corresponding device for determining a fluid level in a fluid container, which enable a high level of accuracy when determining a fluid level.

In accordance with a first aspect, the invention is distinguished by a method and a corresponding device for determining a height of a fluid level in a fluid container, in which a first reference element and a second reference element are provided within a fluid in the fluid container, wherein the first reference element has a first distance from a bottom section of the fluid container and the second reference element has a second distance from the bottom section of the fluid container, a sound measurement transducer comprising a transmitter and a receiver is provided, the transmitter emits a sound signal and sound signals reflected at the fluid level and at the reference elements are recorded by the receiver. A first propagation time difference, a second propagation time difference and/or a third propagation time difference is established for the sound signals recorded by the receiver, wherein the first propagation time difference is determined between a first propagation time of the sound signal emitted by the transmitter and reflected at the first reference element and a second propagation time of the sound signal emitted by the transmitter and reflected at the second reference element. The second propagation time difference is determined between a third propagation time of the sound signal emitted by the transmitter and reflected at the fluid level and the first propagation time and the third propagation time difference is determined between the third propagation time of the sound signal emitted by the transmitter and reflected at the fluid level and the second propagation time. Moreover, a speed of sound is established in the fluid dependent on the first propagation time difference and a predetermined distance between the first reference element and the second reference element. The height of the fluid level over the bottom section of the fluid container is determined dependent on at least one propagation time difference, at least one distance of the first reference element and/or of the second reference element from the bottom section of the fluid container and the established speed of sound.

The propagation times and the propagation time differences of the sound signals emitted by the transmitter and reflected to the receiver of the sound measurement transducer are in each case twice the length of the times that the sound signals require to reach the reference elements or the fluid level from the transmitter.

An advantage of this is that the height of the fluid level can be determined very precisely, even if elements or intermediate layers, which may modify the propagation time of the sound signals, are disposed between the sound measurement transducer and the fluid. The influence of such elements or intermediate layers on the propagation time of the sound signals can be eliminated by this method. In particular, temperature-dependent influences of such elements or intermediate layers can be avoided. Furthermore, it is possible to avoid manufacturing and/or assembly tolerances of such elements or intermediate layers having an influence on the measurement. Moreover, it is possible to dispense with adapting the determination of the level if the thicknesses or materials of such elements or intermediate layers change.

The height of the fluid level can be determined very precisely in this manner. An inaccuracy when determining the height of the fluid level can be restricted to e.g. inaccuracies when determining the time measurement, determining the speed of sound and the position of the first or the second reference element.

In an advantageous embodiment in accordance with the first aspect, the sound measurement transducer is an ultrasonic measurement transducer. An advantage of this is that the fluid level in fluid containers can be measured very well by means of ultrasound.

In an advantageous embodiment, a speed of sound is established in the fluid dependent on the first propagation time difference and a distance between the first reference element and the second reference element and the height of the fluid level over the bottom section of the fluid container is determined dependent on the speed of sound in the fluid, the second propagation time difference and the first distance of the first reference element from the bottom section of the fluid container. An advantage of this is that this allows the height of the fluid level to be determined very precisely. An inaccuracy when determining the height of the fluid level can be restricted to inaccuracies when determining the time measurement, determining the speed of sound and the position of the first or the second reference element.

In accordance with a second aspect, the invention is distinguished by a method and a corresponding device for determining a height of a fluid level in a fluid container, in which a first reference element and a second reference element are provided within the fluid in the fluid container, wherein the first reference element has a first distance from a bottom section of the fluid container and the second reference element has a second distance from the bottom section of the fluid container, a sound measurement transducer comprising a transmitter and a receiver is provided, the transmitter emits a sound signal and sound signals reflected at the fluid level and at the reference elements are recorded by the receiver. A first propagation time difference between a first propagation time of the sound signal emitted by the transmitter and reflected at the first reference element and a second propagation time of the sound signal emitted by the transmitter and reflected at the second reference element is determined for the sound signals recorded by the receiver. A third propagation time difference between a third propagation time of the sound signal emitted by the transmitter and reflected at the fluid level and the second propagation time is determined. The height of the fluid level over the bottom section of the fluid container is determined dependent on the first propagation time difference, the third propagation time difference and the second distance of the second reference element from the bottom section of the fluid container.

The advantages of the second aspect correspond to those of the first aspect.

In an advantageous embodiment of the second aspect, a speed of sound is established in the fluid dependent on the first propagation time difference and a predetermined distance between the first reference element and the second reference element and the height of the fluid level over the bottom section of the fluid container is determined dependent on the speed of sound in the fluid, the third propagation time difference and the second distance of the second reference element from the bottom section of the fluid container.

In a further advantageous embodiment in accordance with the first and the second aspect, the sound measurement transducer is an ultrasonic measurement transducer. An advantage of this is that the fluid level in fluid containers can be measured very well by ultrasound.

### BRIEF DESCRIPTION OF THE DRAWINGS

Exemplary embodiments of the invention are explained below on the basis of the schematic drawings, in which:

FIG. 1 shows a schematic view of a fluid container with a sound measurement transducer and a device for determining a height of a fluid level; and

FIG. 2 shows a flowchart of a program for determining a height of a fluid level in a fluid container.

### DETAILED DESCRIPTION OF THE PRESENTLY PREFERRED EMBODIMENTS

Elements with the same design or function have been provided in all figures with the same references.

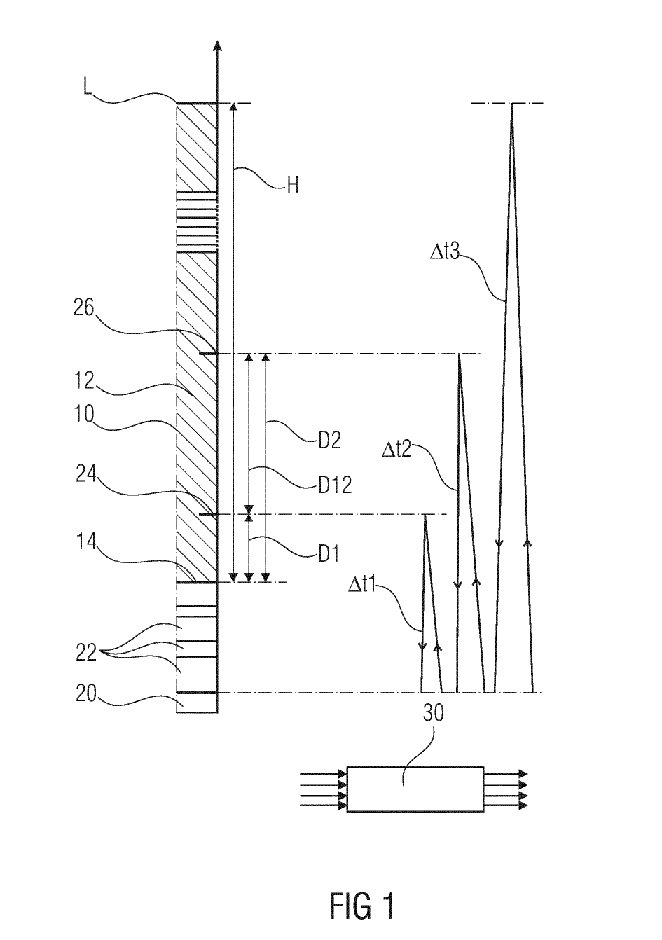

FIG. 1 shows a fluid container 10 containing a fluid 12 with a fluid level L. The fluid container 10 includes a bottom section 14. FIG. 1 furthermore shows a sound measurement transducer 20. The sound measurement transducer 20 is preferably embodied as an ultrasonic measurement transducer. The sound measurement transducer 20 includes a transmission and reception element, which is configured to emit and receive the sound waves. The sound measurement transducer 20 is also referred to as transducer.

Intermediate layers 22 are disposed between the sound measurement transducer 20 and the bottom section 14 of the fluid container 10. The intermediate layers 22 are preferably embodied as adhesive layers or as wall elements of the fluid container 10. In particular, the intermediate layers 22 can serve for coupling the sound transducer 20 to the bottom section 14. In particular, the intermediate layers 22 can, e.g., compensate for small unevennesses of the sound transducer 20 and of the bottom section 14 of the fluid container 10.

Furthermore, a first reference element 24 and a second reference element 26 are disposed in the fluid 12 and in the fluid container 10. The reference elements 24, 26 preferably have a plate-shaped design. The reference elements 24, 26 are preferably made of a material comprising a metal. In further embodiments, the reference elements 24, 26 can also be made of a material comprising a plastic or a ceramic. The reference elements 24, 26 reflect part of the emitted sound signal in the direction of the sound measurement transducer 20. In the preferred embodiment depicted here, the reference elements 24, 26 are arranged along a straight line with the sound measurement transducer 20 and the fluid level L. In further embodiments, the arrangement may also include deflection elements that are able to reflect sound. In such embodiments, the arrangement of the sound measurement transducer 20, the reference elements 24, 26 and the fluid level may also deviate from the arrangement along a straight line.

The first reference element 24 has a first distance D1 from the bottom section 14 of the fluid container 10. The second reference element 26 has a second distance D2 from the bottom section 14 of the fluid container 10.

FIG. 1 also depicts a device 30 that determines a height H of the fluid level L in the fluid container 10. Sensors that detect various measurement variables and are respectively able to establish the value of the measurement variable are assigned to the device 30. The device 30 establishes values dependent on at least one of the measurement variables, by which values the height H of the fluid level L in the fluid container 10 can be established.

The functionality of the sound measurement transducer 20 at the fluid container 10 is briefly illustrated as follows:

Sound waves are emitted by the sound measurement transducer 20 and reach into the fluid 12 through the intermediate layers 22 and the fluid container 10. Depending on the distances D1, D2 of the reference elements 24, 26 from the bottom section 14 of the fluid container 10 and the height H of the fluid level L, different propagation times Δt1, Δt2, Δt3 of the sound signals are obtained in the fluid container 10, starting with the emission of the sound signal by the transmitter of the sound measurement transducer 20 and ending with the reception of the sound signal at the receiver of the sound measurement transducer 20. For improved clarity, the propagation times Δt1, Δt2, Δt3 of the sound signals are in each case depicted separately for the outward and return path. Determining the height H of the fluid level L in the fluid container 10 is explained in more detail below.

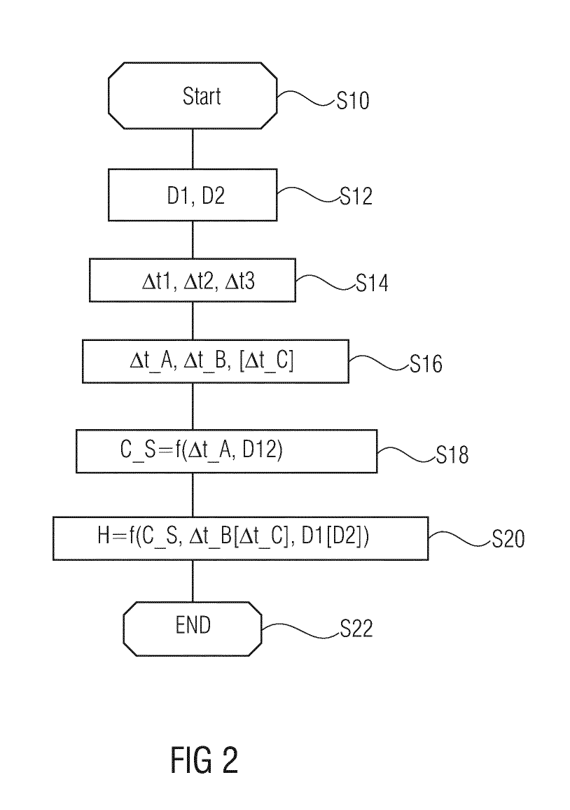

A program, depicted schematically in FIG. 2, for operating the device 30 for determining the height H of the fluid level L in the fluid container 10 is preferably stored on a non-transitory storage medium of the device 30.

The program is preferably started in step S10, in which variables are initialized when necessary. This preferably occurs when the sound measurement transducer 20 is put into operation.

The first distance D1 between the first reference element 24 and the bottom section 14 of the fluid container 10 is provided in step S12. Moreover, the second distance D2 between the second reference element 26 and the bottom section 14 of the fluid container 10 is provided. Working through the program is subsequently continued in step S14.

In step S14, the first propagation time Δt1 of the sound signal reflected at the first reference element 24 is determined by means of the sound measurement transducer 20. Moreover, the second propagation time Δt2 of the sound signal reflected at the second reference element 24 is determined by the sound measurement transducer 20. Moreover, the third propagation time Δt3 of the sound signal reflected at the fluid level L is determined. Working through the program is subsequently continued in step S16.

In step S16, a first propagation time difference Δt_A is determined between the first propagation time Δt1 and the second propagation time Δt2. Furthermore, a second propagation time difference Δt_B is determined between the third propagation time Δt3 of the sound signal reflected at the fluid level L and the first propagation time Δt1. As an alternative to the second propagation time difference Δt_B, a third propagation time difference Δt_C is determined between the third propagation time Δt3 of the sound signal reflected at the fluid level L and the second propagation time Δt2. Working through the program is subsequently continued in step S18.

In step S18, a speed of sound c_S is established in the fluid dependent on the first propagation time difference Δt_A and a distance D12 between the first reference element 24 and the second reference element 26. In particular, the speed of sound c_S is calculated in accordance with equation c_S=2*D12/Δt_A. Working through the program is subsequently continued in step S20.

In step S20, the height H of the fluid level over the bottom section 14 of the fluid container 10 is determined dependent on the speed of sound c_S in the fluid, the second propagation time difference Δt_B and the first distance D1 of the first reference element 24 from the bottom section 14 of the fluid container 10.

Alternatively, the height H of the fluid level over the bottom section 14 of the fluid container 10 is determined dependent on the speed of sound c_S in the fluid, the third propagation time difference Δt_C and the second distance D2 of the second reference element 26 from the bottom section 14 of the fluid container 10. In particular, the height H of the fluid level is calculated according to equation H=c_S*Δt_B/2+D1 or in accordance with the equation H=c_S*Δt_C/2+D2. Working through the program is subsequently continued in step S22.

The program is terminated in step S22. However, the program is preferably executed regularly during the operation of the sound measurement transducer 20.

An advantage consists, firstly, of the fact that the speed of sound c_S can be determined well based on the first propagation time difference Δt_A. In order to determine the height H of the fluid level L over the bottom section 14 of the fluid container as accurately as possible independently of the intermediate layers 22, the second propagation time difference Δt_B or the third propagation time difference Δt_C is moreover established for the purposes of determining the speed of sound c_S. Hence, the accuracy of the determination of the height H of the fluid level L over the bottom section 14 of the fluid container 10 is only still dependent on the accuracy of the timekeeping, the accuracy in determining the speed of sound c_S and the accuracy in determining the distances D1, D2 of the first reference element 24 or of the second reference element 26 from the bottom section 14 of the fluid container 10.

Hence, influences of the intermediate layers 22 on the propagation times of the sound signals between the sound measurement transducer 20 and the fluid level L can be eliminated. This is particularly advantageous since the influence of the intermediate layers 22 on the propagation times of the sound signals between the sound measurement transducer 20 and the fluid level L may also be dependent on temperature. This renders it possible to prevent manufacturing or assembly tolerances of the intermediate layers 22 from influencing the determination of the height H of the fluid level L over the bottom section 14 of the fluid container 10. In particular, it is possible to dispense with adapting the determination of the height H of the fluid level L over the bottom section 14 of the fluid container 10 if, for example, materials or thicknesses of the intermediate layers 22 change for design or manufacturing reasons.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A method for determining a height (H) of a fluid level (L) in a fluid container (10) using a device having: a first reference element (24) and a second reference element (26) within a fluid (12) in the fluid container (10), the first reference element (24) having a first distance (D1) from a bottom section (14) of the fluid container (10) and the second reference element (26) having a second distance (D2) from the bottom section (14) of the fluid container (10), and a sound measurement transducer (20) having a transmitter and a receiver, wherein the sound measurement transducer (20) is disposed at the fluid container (10) and intermediate layers (22) for coupling the sound measurement transducer (20) and the fluid container (10) are disposed between the sound measurement transducer (20) and the fluid container (10), the method comprising:
the transmitter emitting a sound signal and the receiver recording sound signals reflected at the fluid level (L) and at the reference elements (24, 26);
establishing a first propagation time difference (Δt_A) and a second propagation time difference (Δt_B) or a third propagation time difference (Δt_C) for the sound signals recorded by the receiver;
determining the first propagation time difference (Δt_A) between a first propagation time (Δt1) of the sound signal emitted by the transmitter and reflected at the first reference element (24) and a second propagation time (Δt2) of the sound signal emitted by the transmitter and reflected at the second reference element (26);
determining the second propagation time difference (Δt_B) between a third propagation time (Δt3) of the sound signal emitted by the transmitter and reflected at the fluid level (L) and the first propagation time (Δt1);
determining the third propagation time difference (Δt_C) between the third propagation time (Δt3) of the sound signal emitted by the transmitter and reflected at the fluid level (L) and the second propagation time (Δt2);
establishing a speed of sound (c_S) in the fluid (12) based upon the first propagation time difference (Δt_A) and a predetermined distance (D12) between the first reference element (24) and the second reference element (26); and
determining the height (H) of the fluid level (L) over the bottom section (14) of the fluid container (10) based upon the first propagation time difference (Δt_A), the second propagation time difference (Δt_B, Δt_C), the first distance (D1) and the speed of sound (c_S) or based upon the first propagation time difference (Δt_A), the third propagation time difference (Δt_C), the second distance (D2) and the speed of sound (c_S).

9. The method as claimed in claim 8, wherein the sound measurement transducer (20) is an ultrasonic measurement transducer.

10. A device for determining a height (H) of a fluid level (L) in a fluid container (10), comprising:
a first reference element (24) and a second reference element (26) within a fluid (12) in the fluid container (10), the first reference element (24) having a first distance (D1) from a bottom section (14) of the fluid container (10) and the second reference element (26) having a second distance (D2) from the bottom section (14) of the fluid container (10);
a sound measurement transducer (20) arranged at the fluid container (10); and
a transmitter and a receiver, wherein intermediate layers (22) for coupling the sound measurement transducer (20) to the fluid container (10) are disposed between the sound measurement transducer (20) and the fluid container (10), the device being configured to:
emit a sound signal by the transmitter and record sound signals reflected at the fluid level (L) and at the reference elements (24, 26) by the receiver,
determine, for the sound signals recorded by the receiver, a first propagation time difference (Δt_A) between a first propagation time (Δt1) of the sound signal emitted by the transmitter and reflected at the first reference element (24) and a second propagation time (Δt2) of the sound signal emitted by the transmitter and reflected at the second reference element (26),
determine a second propagation time difference (Δt_B) or a third propagation time difference (Δt_C), wherein the second propagation time difference (Δt_B) is established between a third propagation time (Δt3) of the sound signal emitted by the transmitter and reflected at the fluid level (L) and the first propagation time (Δt1) and the third propagation time difference (Δt_C) is established between a third propagation time (Δt3) of the sound signal emitted by the transmitter and reflected at the fluid level (L) and the second propagation time (Δt2), and
determine the height (H) of the fluid level (L) over the bottom section (14) of the fluid container (10) based upon the first propagation time difference (Δt_A), the second propagation time difference (Δt_B) and the first distance (D1) or based upon the first propagation time difference (Δt_A), the third propagation time difference (Δt_C) and the second distance (D2).
